(19) United States
(12) Patent Application Publication
(10) Pub. No.: US 2007/0178529 A1
(43) Pub. Date: Aug. 2, 2007

(54) ELECTROMAGNETICALLY ACTUATED VALVES FOR USE IN MICROFLUIDIC STRUCTURES

(75) Inventors: Wayne L. Breidford, Seattle, WA (US); C. Frederick Battrell, Redmond, WA (US)

Correspondence Address: SEED INTELLECTUAL PROPERTY LAW GROUP PLLC, 701 FIFTH AVE, SUITE 5400, SEATTLE, WA, 98104, US

(73) Assignee: MICRONICS, INC., Redmond, WA (US)

(21) Appl. No.: 11/622,733

(22) Filed: Jan. 12, 2007

Related U.S. Application Data
(60) Provisional application No. 60/758,656, filed on Jan. 13, 2006.

(51) Int. Cl. G01N 33/53

(52) U.S. Cl. 435/7.1; 435/287.2

(57) ABSTRACT

Disclosed are micron-sized, electromagnetically actuated tongue valves, which find application in microfluidic devices and apparatuses. The present invention further relates to methods for manipulating fluid flow in a microfluidic assay system and for sorting and capturing target particles in fluid suspensions.

### CROSS-REFERENCE TO RELATED APPLICATION

This application claims the benefit under 35 U.S.C. § 119(e) of U.S. Provisional Patent Application No. 60/758,656 filed Jan. 13, 2006, which provisional application is incorporated herein by reference in its entirety.

### BACKGROUND OF THE INVENTION

1. Field of the Invention

This disclosure relates generally to improvements in fluid control in microfluidic devices, and more particularly, to micron-sized, electromagnetically actuated valves, microfluidic devices and apparatuses incorporating these valves, and methods for their use.

2. Description of the Related Art

Microfluidic devices are increasingly becoming popular for performing analytical testing. Using tools developed by the semiconductor industry to miniaturize electronics, it has become possible to fabricate intricate microscale fluid systems which can be inexpensively mass produced. Systems have been developed to perform a variety of analytical techniques for the acquisition of information for the medical field.

Microfluidic devices may be constructed in a multi-layered laminated structure wherein each layer has channels and/or structures fabricated from a laminate material to form microscale voids and/or channels in which fluids may flow. Alternatively, microfluidic devices can be fabricated by injection molding. A microscale (or microfluidic) channel is generally defined as a fluid passage which has at least one internal cross-sectional dimension that is less than 500 μm and typically between about 0.1 μm and about 500 μm. The control and pumping of fluids through these channels is effected by, for example, pneumatic bellows and hygrosorbent pads.

U.S. Pat. No. 5,716,852 teaches a method for analyzing the presence and concentration of small particles in a microfluidic flow cell using diffusion principles. The '852 patent, the disclosure of which is incorporated herein by reference, discloses a microfluidic channel cell system for detecting the presence of analyte particles in a sample stream using a microfluidic laminar flow channel having at least two inlet means which provide an indicator stream and a sample stream, where the microfluidic laminar flow channel has a depth sufficiently small to allow laminar flow of the streams and a length sufficient to allow diffusion of particles of the analyte into the indicator stream to form a detection area, and having an outlet out of the channel to form a single mixed stream. Such a device, which may be known as a T-Sensor, may contain an external detecting means for detecting changes in the indicator stream. This detecting means may be provided by any means known in the art, including optical means such as optical spectroscopy, or absorption spectroscopy of fluorescence.

U.S. Pat. No. 5,932,100, which patent is also incorporated herein by reference, teaches another method for analyzing particles within microfluidic channels using diffusion principles. A mixture of particles suspended in a sample stream enters an extraction channel from one upper arm of a structure, which comprises microchannels in the shape of an “H”. An extraction stream (e.g., a dilution stream) enters from the lower arm on the same side of the extraction channel and, due to the size of the microfluidic extraction channel, the flow is laminar and the streams do not mix. The sample stream exits as a by-product stream at the upper arm at the end of the extraction channel, while the extraction stream exits as a product stream at the lower arm. While the streams are in parallel laminar flow in the extraction channel, particles having a greater diffusion coefficient (e.g., small particles such as albumin, sugars and small ions) have time to diffuse into the extraction stream, while the larger particles (e.g., blood cells) remain in the sample stream. Particles in the exiting extraction stream (now called the product stream) may be analyzed within interference from the larger particles. This microfluidic structure, commonly known as an “H-Filter”, can be used for extracting desired particles from a sample stream containing those particles.

Several types of valves are commonly used for fluid management in flow systems. Flap valves, ball-in-socket valves, and tapered wedge valves are a few of the valve types existing in the macroscale domain of fluid control.

However, in the microscale field, where flow channels are often the size of a human hair (approximately 100 microns in diameter), there are special needs and uses for valves which are unique to microscale systems. Special challenges involve mixing, dilution, fluidic circuit isolation, and anti-sedimentation techniques, for example in analyzing fluids with various concentrations of particulates in suspension.

Many different types of valves for use in controlling fluids in microscale devices have been developed. For example, U.S. Patent Application 2005/0275494 describes magnetic pinch valves. U.S. Pat. No. 6,432,212 describes one-way valves (also known as check valves) for use in laminated microfluidic structures, U.S. Pat. No. 6,581,899 describes ball bearing valves for use in laminated microfluidic structures, and U.S. patent application Ser. No. 10/114,890, which application is assigned to the assignee of the present invention, describes a pneumatic valve interface, also known as a zero dead volume valve or passive valve, for use in laminated microfluidic structures. The foregoing patents and patent applications are hereby incorporated by reference in their entirety.

Although there have been advances in the field, there remains a need in the art for electromagnetically controllable valves for use in microscale devices and apparatuses. The present invention addresses these needs and provides further related utility.

### BRIEF SUMMARY OF THE INVENTION

Micromechanical, electromagnetically actuated tongue valves adapted for the laminar flow environment characteristic of microfluidic devices are disclosed. With electromagnetic actuator assemblies, the valves can be used to manipulate fluid flow and to mix fluids at the microscale. Tongue members projecting upstream into fluid flow (“in-flow”) have the hitherto for unanticipated utility described here. Methods, apparatuses, and devices are aspects of the claimed invention.

Disclosed is a method for separating or capturing suspended particles in a microfluidic device, comprising the steps of: Introducing a fluid stream containing a plurality of suspended particles into a first microfluidic channel of a microfluidic device, wherein said particles in said fluid stream are generally flowing in a ribbon surrounded by a fluid sheath from upstream to downstream in said first microfluidic channel; Transporting said ribbon over the leading upstream edge of the tip of a tongue member with magnetically responsive element that projects into the lumen of said first microfluidic channel; Detecting a signal from at least one target particle in said fluid stream at an upstream detection point and processing said signal by calculating a time delay and pulse length time based on the linear velocity of fluid in the first microfluidic channel and the distance between the upstream detection point and the leading upstream edge of the tip of the tongue member; After said time delay, electromagnetically raising said tip of said tongue member into the fluid stream so as to divert a segment of said ribbon containing the target particle into a fluidly connected second microfluidic channel branching from said first microfluid channel; After said pulse duration time, electromagnetically lowering said tip of said tongue member, thereby restoring fluid flow in said first microfluidic channel.

Particularly preferred is the above method wherein said at least one target particle is selected from the group consisting of cell, microsphere and bead, generally a labeled cell, microsphere or bead. Such methods may be automated or semi-automated.

A preferred embodiment is a semi-automated or automated method for manipulating fluid flow in a disposable microfluidic cartridge fitted with a tongue member of the current invention. The cartridge is generally mounted in an apparatus comprising circuit elements and firmware to operate one or a pair of electromagnetic actuator assemblies and optional sensors, which may be mounted in the apparatus external to the body and microfluidic channel in which the tongue is mounted.

Also disclosed is an apparatus for performing these methods. Such apparatus for separating or capturing suspended particles in a microfluidic device may comprise: A means for introducing a fluid stream wherein is suspended a plurality of particles into a first microfluidic channel with lumen of a microfluidic device, wherein said particles in said fluid stream are generally flowing as a ribbon surrounded by a fluid sheath from upstream to downstream in said first microfluidic channel, and are flowing over a tongue member with tip with leading upstream edge that projects into the lumen of said first microfluidic channel; A means for detecting a signal from at least one target particle in said fluid stream at a detection point and for processing said signal by calculating a time delay and pulse duration time based on the linear velocity of fluid in the first microfluidic channel and the distance between the detection point and the tip of the leading upstream edge of the tongue member; A means for electromagnetically raising said leading upstream edge of said tip of said tongue member into the fluid stream after said time delay so as to divert said ribbon containing the target particle into a fluidly connected second microfluidic channel branching from said first microfluid channel; A means for electromagnetically lowering said tip of said tongue member out of the fluid stream after said pulse duration time, thereby restoring fluid flow to said first microfluidic channel and capturing a segment of said ribbon with said at least one target particle.

In another embodiment, an apparatus for separating or capturing suspended particles in a microfluidic device may comprise: A body structure comprising a generally planar substrate; Generally disposed in the plane of said substrate, a microfluidic sorter channel with lumen and with walls, with upstream aspect, and with first downstream branch and second downstream branch, wherein said downstream branches are fluidly connected to said upstream aspect; A tongue member with tip and leading upstream edge of tip projecting upstream in said microfluidic channel, said tip further comprising a magnetically responsive element, and wherein said tip has a first position and a second position; and further wherein said first position occludes said second downstream branch and said second position occludes said first downstream branch of said microfluidic sorter channel; A means for introducing and a means for transporting a fluid stream containing a plurality of suspended particles into said upstream aspect of said microfluidic channel, so that said particles in said fluid stream are generally flowing in a ribbon surrounded by a fluid sheath from upstream to downstream in said microfluidic channel, and are flowing over the leading upstream edge of said tip in its first position and into said first downstream branch of said microfluidic sorter channel; A means for detecting a signal from at least one target particle in said fluid stream at a detection point in said upstream aspect of said microfluidic channel and for processing said signal by calculating a time delay and pulse duration time based on the linear velocity of fluid in the first microfluidic channel and the distance between the detection point and the tip of the tongue member; A means for switching said leading upstream edge of said tip of said tongue from said first position to said second position, wherein said means comprises a means for generating an electric current pulse to a first electromagnetic actuator after said time delay that a segment of said ribbon containing said target particle is diverted into said second microfluidic channel; A means for switching said leading upstream edge of said tip of said tongue from said second position to said first position, wherein said means comprises a means for generating an electric current pulse to a first electromagnetic actuator after said pulse duration time, so that said ribbon flows into said first downstream branch, and a means for collecting said at least one target particle, generally a downstream chamber or reservoir with collection port. Fluid and particles not collected are transported to waste.

The valves of the present invention comprise a body structure with generally planar substrate; a microfluidic channel disposed in the substrate; a tongue member with magnetically deflectable tip projecting upstream into the lumen from a wall of the microfluidic channel; at least one electromagnetic actuator assembly in magnetic proximity to the tip of the tongue; an electric current supply and controller. The tongue member, is configured to redirect fluid flow in the microfluidic channel when the magnetically responsive tip is deflected by the magnetic field of an electric current supplied to the first electromagnetic actuator assembly. The tip of the tongue member is positioned in the lumen of the microfluidic channel upstream from its base of attachment. Provision is also made for attachment of the body to an apparatus supplying pneumatic, fluidic and electrical controls.

The tongue comprises a material selected for a bending limit of elasticity which is greater the nominal deflection angle (in radians) between said first position and said second position. Preferably, the material selected for the tongue has the characteristic of resilience.

The tongue member in one embodiment is a magnetically susceptible metal, made for example from shim stock. In other embodiments, the tongue itself is non-magnetic, but a magnetically responsive element is embedded, coated or attached to the tip of the tongue. This magnetically responsive element may, for example, be dip-coated as part of a soft, elastomeric valve plug on the tip of the tongue.

In another embodiment the tongue member is a metal foil member with tip and base. The base of the metal foil member is embedded in a downstream wall of the microfluidic channel, and the tip of the metal foil member projects upstream in the lumen of the microfluidic channel, where it is free to deflect in the presence of a magnetic field. The tip of the metal foil member may rest on a valve seat, or may come to rest against a valve seat when deflected by the electromagnetic actuator assembly.

In another embodiment the tongue member is a leaf spring with tip and base. The base of the leaf spring is embedded in a downstream wall of the microfluidic channel, and the tip of the leaf spring projects upstream in the lumen of the microfluidic channel, where it is free to deflect in the presence of a magnetic field. The tip of the leaf spring may rest on a valve seat, or may come to rest against a valve seat when deflected by the electromagnetic actuator assembly.

In other embodiments, the electromagnetically actuated tongue valves of the present invention comprise a body structure with generally planar substrate; a microfluidic channel disposed in the substrate; a tongue member with magnetically deflectable tip projecting into the lumen from a wall of the microfluidic channel, a valve seat on which the tip coveringly is positioned, and under the valve seat, a fluidically connected junction of the first microfluidic channel and a second microfluidic channel; wherein the tongue valve is configured to divert fluid flow from the first microfluidic channel to the second microfluidic channel by supplying electric current to an electromagnetic actuator assembly that deflects the tip of the tongue so as to open or close the valve. Provision is also made for attachment of the body to an apparatus supplying pneumatic, fluid and electrical controls.

These tongue valves may also have a second electromagnetic actuator assembly, which is positioned generally opposite the first electromagnetic actuator assembly relative to the plane of the microfluidic channel or tongue, so that by applying current to either of the opposing electromagnetic actuator assemblies, the tip of the tongue is deflected towards the active coil, thus opening or closing the valve in some embodiments, diverting fluid from one microfluidic channel to another in other embodiments, or mixing fluids, reagents and analytes.

A controller is configured to direct electric current to either the first or the second electromagnetic actuator assemblies on command signal, so that the tip of the tongue member is deflected toward either the first or second electromagnetic actuator assemblies in response to a command signal. This command signal optionally is generated by “off-card” firmware within the apparatus.

It should be noted that while a pair of electromagnetic actuator assemblies, or one electromagnetic actuator assembly and a leaf spring with memory, are useful to divert flow, the same apparatus also can serve to mix fluid and disrupt laminar flow. In this latter application, a series of pulses applied to the controller will have the effect of oscillating the magnetically susceptible tongue. By perforating the tongue, mixing can be increased.

In another embodiment the microfluidic channel further comprises an upstream aspect, downstream “vee” and the electromagnet tongue valve, with leading upstream edge of the projecting tip, redirects fluid flow from one arm of the “vee” to the other by switching from a first position to a second position so as to occlude the second downstream arm or the first downstream branch or arm. The downstream first and second branches are fluidically interconnected with the upstream aspect of the primary channel in which the valve is positioned.

Also contemplated are microfluidic cartridges or “cards” comprising a body with substrate; a microfluidic channel for transporting a fluid, with lumen and upstream end; a tongue member with tip and base, wherein said tip further comprises a magnetically responsive element, and further wherein the tip projects into the lumen of the microfluidic channel and is configured to be electromagnetically deflectable between a first position and a second position so that fluid flow is redirected in the channel.

The base of the tongue member is embedded in a wall downstream from the tip. The fluid may be redirected to a branching microchannel, or simply mixed in the microchannel without diversion by the action of the tongue member. The microfluidic cartridges may be fabricated by lamination or by injection molding. The substrate of the body member of the cartridges is comprised of a polymeric material fabricated by a process selected from the group consisting of lamination and molding, or a combination thereof. Optionally, small electromagnetic coils known in the art may be mounted in the body of the cartridge. However, in a preferred embodiment, the coil or coils are mounted externally in an analytical apparatus designed for handling the cartridges, which are optionally disposable.

Multiple electromagnetically actuated tongue valves of the present invention may be disposed within a single microfluidic cartridge.

An apparatus for performing microfluidic analyses is also disclosed. The apparatus is designed to receive a microfluidic cartridge of the kind described above and comprises electromagnetic coils that serve to actuate one or a plurality of electromagnetically actuated tongue valves within the body of the cartridge. The apparatus also supplies pneumatic, fluidic and electrical controls for cartridge-based microfluidic assays.

### BRIEF DESCRIPTION OF THE SEVERAL VIEWS OF THE DRAWINGS

The teachings of the present invention can be readily understood by considering the following detailed description in conjunction with the accompanying drawings, in which:

FIG. 1 is a plan view of an electromagnetically actuated tongue valve according to a first embodiment.

FIG. 2 is a cross-sectional top view of the valve of FIG. 1, with electromagnets shown schematically.

FIG. 3 is a plan view of an electromagnetically actuated tongue valve according to a second embodiment.

FIG. 4 is a section through the electromagnetically actuated valve of FIG. 3, with valve seated ventrally in a microfluidic channel of a body of a representative microfluidic device. Electromagnets of a representative microfluidic apparatus are rendered schematically.

FIG. 5 is a section through a electromagnetically actuated valve according to a second embodiment with valve seated dorsally in a microfluidic channel of a body of a representative microfluidic device. Electromagnets of a representative microfluidic apparatus are rendered schematically.

FIG. 6 is a top view of a representative microfluidic cartridge with an electromagnetically actuated tongue valve essentially of the structure drawn schematically in FIG. 1.

FIG. 7 is a top view and schematic of a representative microfluidic cartridge and apparatus with electromagnetically actuated tongue valve. The device is shown with connection interfaces for external valve pneumatics, pump hydraulics, and valve electronics. Not shown are interfaces for optional external sensor assemblies.

As is understood in the art, note that the drawings are not to scale, and the various elements may have been enlarged, reshaped, and repositioned to improve drawing legibility and clarity.

### DETAILED DESCRIPTION OF THE INVENTION

Although the following detailed description contains many specific details for the purposes of illustration, one of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

1. Definitions

Unless the context requires otherwise, throughout the specification and claims which follow, the word “comprise” and variations thereof, such as, “comprises”, “comprised of”, and “comprising” are to be construed in an open, inclusive sense, that is as in: “including, but not limited to”.

Reference throughout this specification to “one embodiment” or “an embodiment”, and so forth, indicates that a particular feature, structure or characteristic described in connection with the embodiment is included in at least one embodiment of the present invention. Thus, the appearances of the phrases “in a first embodiment” or “in another embodiment” in various places throughout this specification are referring to either the same embodiment or different embodiments, no matter the prepositional phrase. Furthermore, any particular features, structures, or characteristics of the claimed invention may be combined in any suitable manner in one or more embodiments.

Herein, where a “means for a function” is described, it should be understood that the scope of the invention is not limited to the mode or modes illustrated in the drawings alone, but also encompasses all means for performing the function that are described in this specification, and all other means commonly known in the art at the time of filing. A “prior art means” encompasses all means for performing the function as would be known to one skilled in the art at the time of filing, including the cumulative knowledge in the art cited by reference herein to a few representative examples.

“Conventional” is a term designating herein that which is known in the prior art to which this invention relates, particularly that which relates to microfluidic devices and electromagnetism.

“About”, “generally”, “substantially”, and “roughly” are broadening expressions herein, expressing inexactitude, or describing a condition of being “more or less”, approximately, or almost; where variations would be obvious, insignificant, or of lesser or equivalent utility or function, and further indicating the existence of obvious exceptions to a norm, rule or limit.

Microfluidic cartridge: a “device”, “card”, or “chip” having a body or substrate within which are disposed microfluidic structures and internal channels having microfluidic dimensions, i.e., having at least one internal cross-sectional dimension that is less than about 500 μm and typically between about 0.1 μm and about 500 μm. These microfluidic structures may include chambers, lumens, walls, valves, vents, vias, pumps, inlets, nipples, membranes, optical windows, layers, electrodes, mixers, ribbon focusing annuli, and detection means, for example.

Microfluidic channel: Generally, microfluidic channels are fluid passages within a body or substrate, the lumen of which having at least one internal cross-sectional dimension that is less than about 500 μm and typically between about 0.1 μm and about 500 μm. Microfluidic channels generally have upstream and downstream aspects or “ends” corresponding to inlet and outlet or to upstream junction and downstream junction. The lumen of a microfluidic channel is bounded by its walls.

Via: A step in a microfluidic channel that provides a fluid pathway from one substrate layer to another substrate layer above or below, as is conventional in laminated devices built from layers.

Tongue: As used herein, a tongue is a protruding member generally with length greater than width or depth, and may be a foil, a sheet, a film, a rod, a beam, or even a microsphere on a filament. A tongue has a tip and a base, and the base is generally the anchor point where the tongue is affixed to a substrate. The tip of the tongue projects into the lumen of a microfluidic channel in the upstream direction, referring to the direction of fluid flow. The direction of fluid flow is always downstream.

Members that deflect without inelastic deformation (plastic) within the operating parameters of the valve are preferred, and such materials are readily selected. For a given material, at the required cross-sectional area, there is generally an ‘elastic region’in the bending force (stress)/deflection (strain) curve, defined conventionally as the region in the curve where E, the modulus of elasticity (here determined as a bending or a flexural modulus), is more or less constant. The elastic region for bending strain has an upper bound, known as the “elastic limit”, where the slope of the force/deflection curve departs from E. The nominal deflection of the tongue under the intended operating parameters is determined by the geometry of the valve, and suitable materials are selected by ensuring that i) the nominal deflection lies within the elastic region and below the elastic limit and ii) the force on the tongue required to induce that deflection is achievable.

Materials with E between 1 GPa and 300 GPa are contemplated, but a high E material is not required. Thus, tongue materials can be selected from metals and polymers. In a first embodiment, metal foils with E ranging from 50 to 300 GPa, thicknesses up to 60 microns, and with magnetic permeabilities above 100 μN/A² are preferred. Suitable polymers having E as low as 1 GPa include polyamides, polyimides, polytetrafluoroethylene-ethylene copolymers, polyurethanes, polyether block amides (Pebax®) and poly-xylylene (Parylene®) sheets and filaments. Also suitable are selected fiber-reinforced, ceramic composite, and metallized polymers.

In selected embodiments, the tongue can behave as a Hooke's Law member when deflected, i.e., as a spring, although suitable materials are not limited to such.

Tongue materials of the claimed invention comprise materials selected for a bending elastic limit which is greater than the nominal deflection angle (in radians) when in operation. Preferred materials have the characteristic of elastic resilience (low hysteresis up to the elastic limit when subjected to cyclic deformation, conventionally defined as the ratio of the elastic modulus and the yield strength) and are not subject to fatigue within the expected life of the valve. The modulus of resilience (which also can be derived from the force/deflection curve, and is the strain energy density up to the bending yield strength, in kJ/m³) is a good measure of this. Materials with high yield strength and low modulus of elasticity are generally more resilient, and encompass materials that return to their original shape following a deformation of shape or position, as in bending.

Magnetically responsive element: Here limited to a tongue member, or element thereof, fabricated from a paramagnetic, superparamagnetic or magnetic material, such as an iron, for example an iron:cobalt alloys, iron: neodymium alloys, cobalt:chromium:nickel alloys, a Fe₂O₃ composite, nickel, ceramic, or magnetized polymer and ceramic bonded composites. A tongue member may be fabricated to comprise an element or part thereof that is magnetically responsive, as by dip, coating, printing or embedding processes, and like prior art means. In one preferred embodiment, the magnetically responsive element is associated with the tip of the tongue. In other preferred embodiments, the tongue member is fabricated from a magnetically responsive composition, such as a ferrous metal foil.

Electromagnetic actuator assembly: Generally a coil with windings in which the flow of electric current induces a focused magnetic field. The coil may be spiral, conical, or wound, and may be designed to produce a shaped magnetic field. A magnetically permittive core is often used to further concentrate the magnetic flux density at the poles of the core. “Horseshoe-shaped” cores may also be used.

Particle or Particulate: are used to refer to cells, both bacterial and eukaryotic, and to beads, where beads refer to inanimate particles, nanoparticles or microspheres and aggregates that may be formed from latex, polymer, ceramic, silicate, gel or a composite of such, and may contain layers. Beads are classified here on the basis of size as large (1.5 to about 50 microns), small (0.7-1.5 microns), or colloidal (<200 nm), which are also referred to as nanoparticles. Beads are generally derivatized for use in affinity capture of ligands, but some beads have native affinity based on charge, dipole, Van der Waal's forces or hydrophobicity. Labels or tags, such as fluorophores, QDots, and other related detection means, can be used to aid in sorting, enriching, and isolating particles, beads or cells based on binding of the label to the target particle species.

Firmware: Hardwired logic circuits, generally on a custom microchip and circuit board.

Sensor: Comprises detection and control signal means as part of an assay apparatus, including but not limited to spectrophotometer, fluorometer, luminometer, photomultiplier tube, photodiode, nephlometer, photon counter, laser, electrodes, ammeter, voltmeter, capacitative sensors, radio-frequency transmitter, magnetoresistometer, or Hall-effect device. Magnifying lenses in the cover plate, optical filters, colored fluids and labeling may be used to improve detection. Detection of particles may be enhanced with “labels” or “tags” including, but are not limited to, dyes such as chromophores and fluorophores; radio frequency tags, plasmon resonance, or magnetic moment. Molecular beacons are used similarly. Detection systems are optionally qualitative, quantitative or semi-quantitative. Signals from a sensor are, for example, used to drive firmware that in turn controls one or more electromagnetically actuated tongue valves in a microfluidic cartridge. The sensor or sensors may be mounted in the microfluidic cartridge, or more preferentially, are mounted in an apparatus within which the microfluidic cartridge is engaged during an assay.

2. Selected Embodiments

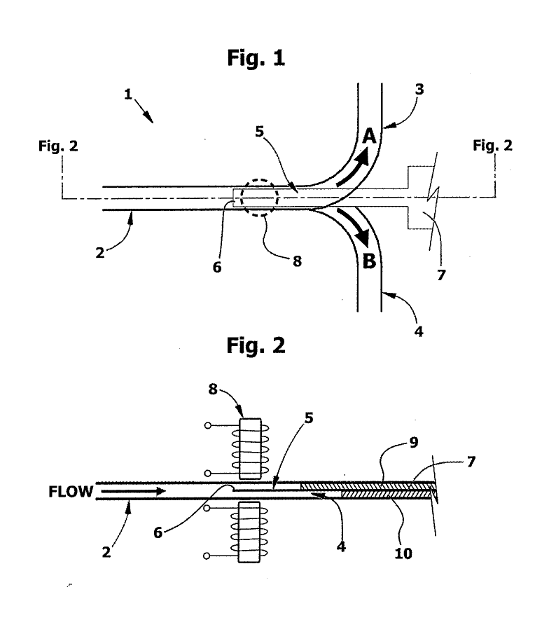

Referring now to the figures, FIG. 1 is a pictographic representation of a microfluidic electromagnetically actuated tongue valve (1). Shown is a microfluidic channel 2 with bifurcated downstream flow channels 3 (upper) and 4 (lower). In use, fluid enters the channel from the left. Tongue member 5, with tongue tip 6 and base 7, under control of at least one electromagnet coil assembly 8 (dotted circle) positioned in magnetic proximity to the tip of the tongue member, moves up and down in the microfluidic channel and directs fluid flow into one of two downstream arms, either the upper arm 3 or the lower arm 4. Arrows “A” and “B” represent the alternate fluid paths extending downstream from the valve.

The longitudinal section marked in FIG. 1 is shown in FIG. 2. The position of electromagnets 8 above and below the tip of the tongue is now clear. Tongue member 5 can be seen to close fluid path B when deflected downward by the lower electromagnet, and closes fluid path A when deflected upward. The tongue member is embedded between layers 9 and 10 of the body of a microfluidic device. No vias are required in this design.

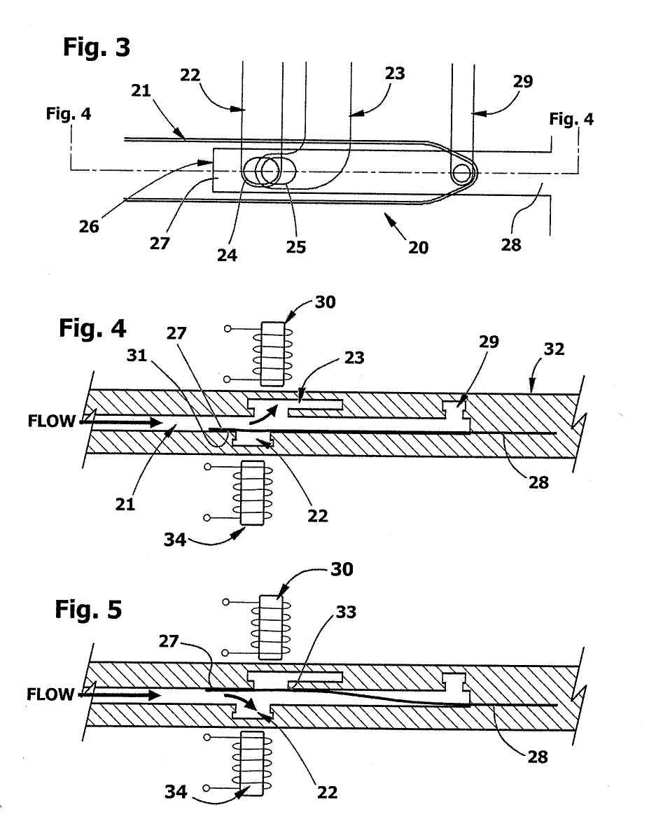

Turning to FIG. 3, a second embodiment of an electromagnetic tongue valve 20 is illustrated. We see a different design of the fluid paths and working of the tongue valve. Microfluidic channel 21 branches into two downstream channels 22 and 23. Channels 22 and 23 are fluidically connected to channel 21 at vias 24 and 25. Tongue member 26 has tip 27 and base 28. Base 28 is embedded in the body of a microfluidic device. Tip 27 rests in the lumen of microfluidic channel 21 and seats on via 24 in the manner of a valve plug on a valve seat. The electromagnetic coil assembly overlying the tongue tip is not shown for clarity. Channel 29 is a vent and is used to prime the fluid path.

Operation of the valve is illustrated in cross-sectional views in FIG. 4 and 5. In FIG. 4, flow entering from the left in the primary microfluidic channel 21 is diverted up (arrow) into branch channel 23 in normal operation. The tongue tip 27 is shown to rest on the valve seat 31 (“rim” or “lip” of the via) of branch channel 22. The lower electromagnet (“valve close” electromagnet, 34) seals the branch. Electromagnets 30 and 34 are external to the microfluidic channel lumen, and as shown here are also external to the microfluidic cartridge body 32. The electromagnets are preferably part of a larger apparatus in which the cartridge is inserted, as will be described below.

In FIG. 5, flow entering from the left in the primary microfluidic channel 21 is diverted down (arrow) into branch channel 22. The tongue tip 27 or valve plug is seated against the “rim” or “lip” of the upper via 33. The tongue member is now visibly deflected in response to activation of the upper electromagnet (“valve open” electromagnet 30) and extends in a curve from base 28 to tip 27. In a working model of this embodiment, the height of the channel over which the tongue is deflected is less than 125 microns. As built, the thickness of the tongue is about 25 microns (1 mil).

In a practical application of the valve mechanism described in FIGS. 3-5, the electromagnetically actuated tongue valve comprises a metal foil tongue 26 (FIG. 3) disposed in the body of a microfluidic device. The valve is normally closed (as in FIG. 4) and diverts the flow of liquid to a waste reservoir through the upper branching microchannel 23. When a analyte of interest is detected, the valve-open electromagnet is activated to move the metal foil up against the top of the microfluidic channel (see FIG. 5), thereby diverting the flow of the sample liquid to the lower branching microchannel 22. In the illustrated embodiment, the tongue member is positioned between two opposing electromagnets (the “valve open” electromagnet coil 30 and the “valve close” electromagnet coil 34 ), which may be alternately turned on and off to open and close the valve (i.e., here, move the metal foil up and down). As one of ordinary skill in the art will appreciate, when neither electromagnet is turned on, the metal foil can rest against the lower valve seat in the microfluidic channel, thereby directing the flow of the sample liquid to the waste cell reservoir. A leaf spring member will operate in this way. In such embodiments, only one electromagnet need be provided to open the valve. When the electromagnet is turned off, the valve will close itself due to the recovery of the spring stock or elastic member. However, as one of ordinary skill in the art will appreciate, embodiments utilizing two electromagnets will enable the position of the valve to be changed more quickly and to seat more firmly.

A preferred tongue material is fabricated from 1 mil mild steel shim stock and is relatively inelastic. It should be clear that tongue members comprised of a plastic substrate to which a magnetically responsive element has been affixed at the tip, as by coating, printing, or dipping, may be substituted for metal foil. Tongue members may also be modified at the tip by providing a valve plug.

In selected embodiments, the electromagnets may be rapidly, and alternately, actuated to rapidly move the metal foil up and down, thereby providing a means for mixing the fluid flowing through the microfluidic channel.

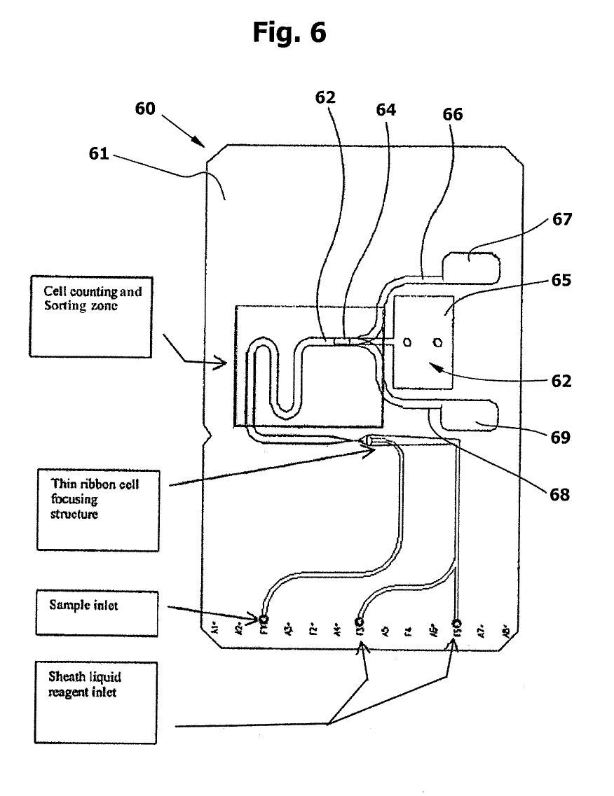

Turning now to FIG. 6, a working model of a microfluidic device or cartridge comprised of an electromagnetically actuated tongue valve is represented schematically in plan view. Microfluidic channel 62, and downstream branches 66 and 68 are disposed in the substrate 61 of body 60. Branch channel 66 is fluidically connected to collection chamber 67. Branch channel 68 is connected to a second collection chamber 69. The tongue member 62 is embedded in the body substrate at 65, and the tongue protrudes into the primary microfluidic channel 62, terminating at tongue tip 64.

Operation of the device of FIG. 6 is generally as follows: a sample liquid is introduced the device via a sample inlet and a sheath liquid reagent is introduced into the device through one or more sheath liquid reagent inlets. A bellows pump or off-card pump may then be utilized to push (or pull) the sample liquid and the sheath liquid reagent through a ribbon cell focusing structure to form a thin “ribbon” or “core” of sample surrounded by a liquid sheath reagent. While in this thin ribbon formation, labeled particles of interest may be detected in the counting and sorting zone (box, FIG. 6). The tongue member 62 is utilized to divert the flow of sample ribbon (and sheath liquid) into branch channel 66 to the first collection chamber 67 when a labeled or target particle of interest is detected. When no particles of interest are detected, the electromagnetically actuated valve diverts flow into branch channel 68 the second collection chamber 69.

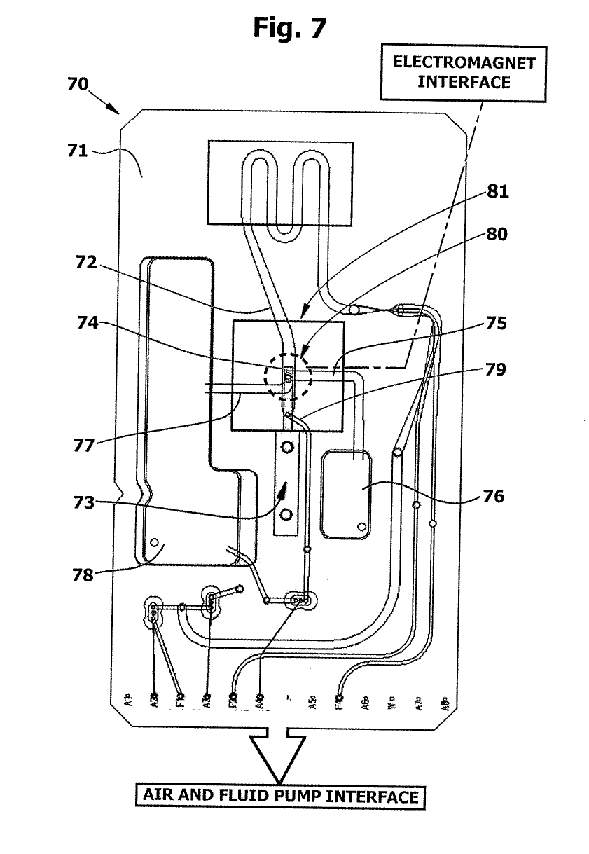

FIG. 7 is a plan view of another embodiment of the electromagnetically actuated tongue valve disposed in a representative device and apparatus. The body, or “card”, 70 engages an external analytical apparatus at the air and fluid pump interface (as marked). Provision is made in the analytical apparatus for a power and control interface (as marked) for the electromagnetic coils (80, dotted circle), also operated externally. Within the device, microfluidic channel 72 transports fluid to or through the tongue valve, where valve seats and branching channels 75 and 77 are provided. Tongue member 73 has a tongue tip 74 that rests within the valve seat area. Branch channel 77 is fluidically connected to waste chamber 78 with vent. Branch channel 75 is fluidically connected to an analyte collection chamber 76 with sampling port. Channel 79 is a vent with valve and is used for priming the fluid path.

In operation, the electromagnetically actuated valve apparatus, here comprising members 73, 80 and associated microfluidic channels, with branches, vias and valve seats (within outline of box 81), as well as off-card electromagnet interface, is utilized to divert the flow of the sample liquid to the analyte collection chamber 76 when a particle or bead of interest is captured. When no particles of interest are detected, the valve diverts the flow of the sample liquid to the waste cell chamber 78. Note the multiple ports (solid circles) for connection of external pneumatic valve control and fluid pumping means from external apparatus to cartridge body. The cartridge body is detachably interfaceable with the apparatus through a pneumatic and fluidic interface and an optional electrical interface.

A complete analytical apparatus is not shown. However, it is contemplated that the tongue valve of the present invention and microfluidic cartridges with the tongue valve of the present invention, may be configured to be operated within a larger analytical apparatus. Optionally, small electromagnetic coils known in the art may be mounted in the body of the cartridge, with contact points for power connecting to an external power source. However, in a preferred embodiment, the coil or coils are mounted externally in an analytical apparatus designed for handling the cartridges, which are optionally disposable. Provisions in such analytical apparatuses necessary for proper operation of the tongue valve include a controllable electromagnetic field, generally of a coil of any of a number of shapes and a supply of electric current, and suitable means for transporting fluid within the microfluidic channels of the valve. Also contemplated in such analytical apparatuses are sensors as detection means and as signaling means for command and control. Optical sensors can, for example, serve as inputs for firmware that directs actuation of the valve in response to a signal triggered by the sample flow through the sensor.

In each of the foregoing embodiments, the composition of the tongue of the electromagnetically actuated valve is preferably, but not limited to, metal foil or shim stock, such as of mild steel or permalloy. Polymers are also contemplated, as are composites comprising magnetically responsive elements. Tongue projections may be pliable or may be elastic, and are generally deformable under weak force. Preferably, the projecting tongue member is about 25 μm thick, but may range from 5 μm to 200 μm in thickness. Projecting tongue member widths are preferably 200 to 400 μm, but may range from 20 to 500 μm in thickness as required. The valve seat, generally but not limited to a via, may range in greatest span from 40 μm to 1.5 μm, but is preferentially in the order of 100 to 200 μm in greatest span.

Representative electromagnets which may be utilized to actuate the valves provided include solenoid coils (e.g., Guardian Electric Manufacturing Co. #TP3.5×9-1-12VDC), and relay coils (e.g., Guardian Electric Manufacturing Co. #1575S 12VDC, NEC ET1-B3M1S, Tyco TSC-112D3H, and Tyco OUAZ-112D). Planar spiral coils may be fabricated as described in Ko (Ko CH et al. 2002. Efficient magnetic microactuator with an enclosed magnetic core. J Magnetism Mag Materials 281:150-172). Other suppliers include AEC Magnetics, Cincinnati OH and APW Company, Rockaway N.J.

While the above is a complete description of the preferred embodiment of the present invention, it is possible to use various alternatives, modifications and equivalents. Therefore, the scope of the present invention should be determined not with reference to the above description but should, instead, be determined with reference to the claims, along with their full scope of equivalents. The claims are not to be interpreted as including means-plus-function limitations, unless such a limitation is explicitly recited in a given claim using the phrase “means for”.

### EXAMPLE 1

The following summarizes representative electrical circuit and design specifications for a cell sorting application involving a microfluidic device comprising an electromagnetically actuated valve of the present invention.

Electrical

When a cell of interest is detected (by, for example, optical sensors and software systems), a trigger signal (by, for example, a pre-programmed software system) is sent causing one of two circuits to turn off and the other circuit to turn on. The two circuits control the “valve close” electromagnet and the “valve open” electromagnet (see for illustration FIG. 4). The “valve close” electromagnet is normally on and pulls a metal foil valve down to assure full closure of the port leading to the sorted cell reservoir. The “valve open” electromagnet is normally off and is activated when the “valve close” electromagnet is deactivated to open the port leading to the sorted cell reservoir.

The port leading to the sorted cell reservoir stays open a set time period after each trigger signal. The length of the time period is adjustable. In the event that a second trigger signal is sent before the time period is over from the first trigger, the timer will reset. Thus, every target cell selected will have the full time to flow up to and through the port leading to the sorted cell reservoir.

Co-assigned and co-pending U.S. Patent Application 2006/0246575 describes microfluidic cell detectors and sorters. It should be clear that the valves of the present invention may be used in sorting, enriching, and harvesting a any kind of cells and particles.

Resonant circuits comprising two or more inductive elements are also contemplated. A diode across the leads of the coil in the electromagnetic actuator assembly serves to protect control circuitry in the power supply.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the invention can be modified, if necessary, to employ systems, components and concepts of the various patents, applications and publications to provide yet further embodiments of the invention.

While particular steps, elements, embodiments and applications of the claimed invention have been shown and described herein for purposes of illustration, it will be understood, of course, that the invention is not limited thereto, because modifications may be made by persons skilled in the art, particularly in light of the foregoing teachings, without deviating from the spirit and scope of the claimed invention.

1. A method for separating or capturing suspended particles in a microfluidic device, comprising the steps of:
a) Introducing a fluid stream containing a plurality of suspended particles into a first microfluidic channel of a microfluidic device, wherein said particles in said fluid stream are generally flowing in a ribbon surrounded by a fluid sheath from upstream to downstream in said first microfluidic channel;
b) Transporting said ribbon over the leading upstream edge of the tip of a tongue member with magnetically responsive element that projects into the lumen of said first microfluidic channel;
c) Detecting a signal from at least one target particle in said fluid stream at an upstream detection point and processing said signal by calculating a time delay and pulse length time based on the linear velocity of fluid in the first microfluidic channel and the distance between the upstream detection point and the leading upstream edge of the tip of the tongue member;
d) After said time delay, electromagnetically raising said tip of said tongue member into the fluid stream so as to divert a segment of said ribbon containing the target particle into a fluidly connected second microfluidic channel branching from said first microfluid channel;
e) After said pulse duration time, electromagnetically lowering said tip of said tongue member, thereby restoring fluid flow in said first microfluidic channel.

2. A method of claim 1, wherein said at least one target particle is selected from the group consisting of cell, microsphere and bead.

3. A method of claim 1, wherein said at least one target particle is a labeled particle.

4. A method of claim 1, wherein the method is automated or semi-automated.

5. An apparatus for performing the method of claim 1.

6. An apparatus for separating or capturing suspended particles in a microfluidic device, comprising:
a) A means for introducing a fluid stream wherein is suspended a plurality of particles into a first microfluidic channel with lumen of a microfluidic device, wherein said particles in said fluid stream are generally flowing as a ribbon surrounded by a fluid sheath from upstream to downstream in said first microfluidic channel, and are flowing over a tongue member with tip with leading upstream edge that projects into the lumen of said first microfluidic channel;
b) A means for detecting a signal from at least one target particle in said fluid stream at a detection point and for processing said signal by calculating a time delay and pulse duration time based on the linear velocity of fluid in the first microfluidic channel and the distance between the detection point and the tip of the leading upstream edge of the tongue member;
c) A means for electromagnetically raising said leading upstream edge of said tip of said tongue member into the fluid stream after said time delay so as to divert said ribbon containing the target particle into a fluidly connected second microfluidic channel branching from said first microfluid channel;
d) A means for electromagnetically lowering said tip of said tongue member out of the fluid stream after said pulse duration time, thereby restoring fluid flow to said first microfluidic channel and capturing a segment of said ribbon with said at least one target particle.

7. An apparatus for separating or capturing suspended particles in a microfluidic device, comprising:
a) A body structure comprising a generally planar substrate;
b) Generally disposed in the plane of said substrate, a microfluidic sorter channel with lumen and with walls, with upstream aspect, and with first downstream branch and second downstream branch, wherein said downstream branches are fluidly connected to said upstream aspect;
c) A tongue member with tip and leading upstream edge of tip projecting upstream in said microfluidic channel, said tip further comprising a magnetically responsive element, and wherein said tip has a first position and a second position; and further wherein said first position occludes said second downstream branch and said second position occludes said first downstream branch of said microfluidic sorter channel;
d) A means for introducing and a means for transporting a fluid stream containing a plurality of suspended particles into said upstream aspect of said microfluidic channel, so that said particles in said fluid stream are generally flowing in a ribbon surrounded by a fluid sheath from upstream to downstream in said microfluidic channel, and are flowing over the leading upstream edge of said tip in its first position and into said first downstream branch of said microfluidic sorter channel;
e) A means for detecting a signal from at least one target particle in said fluid stream at a detection point in said upstream aspect of said microfluidic channel and for processing said signal by calculating a time delay and pulse duration time based on the linear velocity of fluid in the first microfluidic channel and the distance between the detection point and the tip of the tongue member;
f) A means for switching said leading upstream edge of said tip of said tongue from said first position to said second position, wherein said means comprises a means for generating an electric current pulse to a first electromagnetic actuator after said time delay that a segment of said ribbon containing said target particle is diverted into said second microfluidic channel;
g) A means for switching said leading upstream edge of said tip of said tongue from said second position to said first position, wherein said means comprises a means for generating an electric current pulse to a first electromagnetic actuator after said pulse duration time, so that said ribbon flows into said first downstream branch.
h) A means for collecting said at least one target particle.

8. An apparatus of claim 7, wherein said first downstream branch of said microfluidic sorter channel is fluidly connected to a waste outlet and said second downstream branch is fluidly connected to a particle collection means.

9. A micromechanical, electromagnetically actuated tongue valve comprising:
a) A body structure comprising a generally planar substrate;
b) Generally disposed in the plane of said substrate, a first microfluidic channel with lumen and walls and with upstream end and downstream end;
c) A tongue member with base and deflectable tip projecting into the lumen from a wall of the microfluidic channel, wherein said tip further comprises a magnetically responsive element;
d) A first electromagnetic actuator assembly with coil in magnetic proximity to said tip and external to the lumen of the microfluidic channel;
e) A controllable first electric current supply to the first electromagnetic actuator assembly; and,
f) Further wherein said tip of said tongue member is configured to redirect fluid flow in the microfluidic channel when deflected between a first position and a second position by an electric current supplied to the first electromagnetic actuator assembly.

10. A valve of claim 9, further wherein the tip of the tongue member is positioned in the lumen upstream from the base.

11. A valve of claim 9, wherein the first microfluidic channel further comprises a downstream “vee” and said valve redirects fluid flow between the arms of said “vee”.

12. A valve according to claim 9, wherein the tongue comprises a material selected for a bending elastic limit greater than the nominal deflection angle (in radians) between said first position and said second position.

13. A tongue of claim 12, wherein the material selected for the tongue has the characteristic of resilience.

14. A micromechanical, electromagnetically actuated tongue valve comprising:
a) A body structure comprising a generally planar substrate;
b) Generally disposed in the plane of said substrate, a first microfluidic channel with lumen and walls and with upstream end and downstream end;
c) A tongue member with base and deflectable tip projecting into the lumen from a wall of the microfluidic channel, wherein said tip further comprises a magnetically responsive element;
d) A valve seat on which the tip coveringly is positioned;
e) Under said valve seat, a fluidically connected junction of the first microfluidic channel and a second microfluidic channel;
f) A first electromagnetic actuator assembly with coil in magnetic proximity to said tongue and external to the lumen of the microfluidic channel;
g) A controllable electric current supply to the first electromagnetic actuator assembly; and,
h) Further wherein said tip of said tongue member is configured to divert fluid flow from said first microfluidic channel to said second microfluidic channel when deflected between a first position and a second position by an electric current to the first electromagnetic actuator assembly.

15. A valve according to claim 14, wherein the tongue comprises a material selected for a bending limit of elasticity which is greater the nominal deflection angle (in radians) between said first position and said second position.

16. A tongue according to claim 15, wherein the material selected for the tongue has the characteristic of resilience.

17. A valve according to either claim 9 or claim 14, further comprising a second electromagnetic actuator assembly with coil positioned generally opposite the first electromagnetic actuator assembly relative to the plane of the substrate, and a controllable electric current supply to the second electromagnetic actuator assembly.

18. A valve according to claim 17, wherein said controllable electric current supply to said first and second electromagnetic actuator assemblies further comprises a controller.

19. A valve according to claim 18, wherein said controller is configured to direct electric current to either said first or said second electromagnetic actuator assemblies on command signal, so that said tip of said tongue member is deflected toward either said first or second electromagnetic actuator assemblies in response to said command signal.

20. A controller according to claim 18, wherein said controller is comprised of firmware.

21. A valve according to claim 17, wherein the tip of the tongue member further comprises at least one valve plug.

22. A microfluidic cartridge comprising a body with substrate; a microfluidic channel for transporting a fluid, with lumen and upstream end; a tongue member with tip and base, wherein said tip further comprises a magnetically responsive element, and further wherein the tip projects into the lumen of the microfluidic channel and is configured to be electromagnetically deflectable between a first position and a second position so that fluid flow is redirected in the channel.

23. A microfluidic cartridge according to claim 22, wherein said substrate is comprised of a polymeric material selected from the group consisting of laminated and molded.

24. An apparatus for performing microfluidic clinical analyses, comprising a cartridge of claim 22 and further comprising a detachable interface for pneumatic and hydraulic control.

25. A valve according to claim 17, wherein said tongue member is a metal foil with tip and base.

26. A tongue member according to claim 25, wherein the base of said metal foil is embedded in a downstream wall of said microfluidic channel, and further wherein the tip of said metal foil projects upstream in the lumen of said microfluidic channel.

27. A valve according to claim 17, wherein said tongue member is a leaf spring with tip and base.

28. A tongue member according to claim 27, wherein the base of said leaf spring is embedded in a downstream wall of said microfluidic channel, and further wherein the tip of said leaf spring projects upstream in the lumen of said microfluidic channel.

29. An automated method for mixing a fluid in a microfluidic channel, comprising the steps of:
a) Applying a string of digital signals to a controller controlling an electric current supply;
b) Supplying current pulses to at least one electromagnetic actuator assembly in response to said digital signals;
c) Electromagnetically opening and closing a tongue valve in said microfluidic channel in response to said current pulses, so that fluid flow is turbulently perturbed and mixed.

30. An apparatus comprising a microfluidic cartridge and means for performing the mixing method of claim 29.

31. A microfluidic cartridge according to claim 30, further comprising a tip of a tongue with magnetically responsive element, and further, configured as a mixer so that sample liquid flowing in the channel is mixed when said tip is deflected back and forth by at least one electromagnetic actuator assembly in magnetic proximity to said magnetically responsive element in response to a series of electrical current pulses applied to said actuator.
